(19) United States
(12) Patent Application Publication
(10) Pub. No.: US 2019/0012734 A1
(43) Pub. Date: Jan. 10, 2019

(54) PLATFORM, SYSTEMS, AND METHODS FOR INTERCEPTION OF DATA STREAM TRIGGERS

(71) Applicant: Investable Games Technology Inc., Newport Beach, CA (US)

(72) Inventors: Walter CRUTTENDEN, Corona del Mar, CA (US); Mark DRU, Venice, CA (US); Jason MARTELL, Mission Viejo, CA (US); Stephen TYSZKA, Coto de Caza, CA (US); Jack ZEINEH, Newport Coast, CA (US); Walter SCACCHI, Corona Del Mar, CA (US); Yuan YAO, Aliso Viejo, CA (US); Berat BEKCE, Westminster, CA (US)

(21) Appl. No.: 16/030,320

(22) Filed: Jul. 9, 2018

Related U.S. Application Data
(60) Provisional application No. 62/530,770, filed on Jul. 10, 2017.
(60) Provisional application No. 62/594,727, filed on Dec. 5, 2017.
(60) Provisional application No. 62/624,845, filed on Feb. 1, 2018.

(51) Int. Cl. G06Q 40/02; G06Q 20/36

(52) U.S. Cl. CPC G06Q 40/02; G06Q 20/36

(57) ABSTRACT

Provided herein are platforms, systems, and methods for interception of data stream triggers, in particular platforms, systems, and methods that is further related to controlling savings and investments through electronic video game playing and streaming media viewing. In some embodiments, this may include platforms, systems, and methods for facilitating savings and investments through individual, group, or third-party actions. In some embodiments, the actions of interest are those that utilize event handlers or computational triggers to drive savings and investments through self, group, or third-party sponsored game play or viewing of streaming media broadcast.

### CROSS-REFERENCE

This application claims priority to U.S. Provisional Application Nos. 62/530,770, filed Jul. 10, 2017, U.S. Provisional Application No. 62/594,727, filed Dec. 5, 2017, and U.S. Provisional Application No. 62/624,845, filed Feb. 1, 2018, all of which are incorporated herein by reference in their entireties.

### BACKGROUND OF THE INVENTION

Savings are defined as income not spent (i.e., deferred consumption) such as, for example, money put aside in a bank. A deposit account paying interest is often used to hold money for future needs. Typically, conventional saving methods earn low, fixed rates, and present correspondingly lower risks than investments. Related to savings, some consumers choose investments to reach bigger, long-term goals. Investments have the potential for a higher return than a traditional savings account.

Computer and video game play is a widespread form of popular entertainment worldwide. With the growing level of professionalism in competitive game play, third-parties have begun to organize sponsored game tournament events where game players or player teams compete for prize pools and financial rewards that are provided by event or product sponsors, or crowdfunded by game playing/viewing enthusiasts. Streaming media broadcast events, such as broadcasted sporting events, have historically been a large part American household and have garnered wide acceptance over the years. Streamed electronic video game events have also gained acceptance in recent times.

### SUMMARY OF THE INVENTION

This disclosures relates to platforms, systems, and methods for interception of data stream triggers, in particular platforms, systems, and methods that is further related to controlling savings and investments through electronic video game playing and streaming media viewing. In some embodiments, this may include platforms, systems, and methods for facilitating savings and investments through individual, group, or third-party actions. In some embodiments, the actions of interest are those that utilize event handlers or computational triggers to drive savings and investments through self, group, or third-party sponsored game play or viewing of streaming media broadcast. In some embodiments, the event handlers or computation triggers utilizes specific rules in a specific format, which may result in achieving an improved technological result. Optionally, the utility of certain event handlers or computation triggers may offer specific improvement in computer functionality or the way computers operate.

At this time, there is no clear or obvious path for associating the efforts of third-parties to sponsor game players through ways and means that allow for their winnings to be tied to savings and investment services. There also has been recent emphasis on educational games, games with a purpose, serious games, workplace training games, and others where developers and players are using available mechanisms present in hedonistic games for educational, training or learning purposes. Furthermore, other third-parties are looking for new ways to motivate the savings and investment behavior activities of family members or students who are already enthusiastic game players, but who do not associate such focused game play or streaming media viewing effort with activities like saving funds for college or trade school tuition, or for investing funds that often are used in the future for career skill development or other personal goals. Sponsored game play is thus an unrecognized and unfilled opportunity for combining intrinsically motivated interest in video game play together with behavioral activities that engage game players in savings and investment services as a byproduct of their game play. Similarly, there is an unrecognized and unfilled opportunity for combining this same kind of interest and activities for non-sponsored game players, who may thus act to sponsor themselves as game players engaging in savings and investment services as a byproduct of their game play.

Regarding streamed events, each such streamed event may contain event actions, such as a touchdown in Football, or a bomb defuse in the computer game Counter-Strike. Individuals have been utilizing these streamed event actions for a variety of purposes, such as fantasy sports. In some embodiments, the same streamed event actions are be utilized as triggers for savings and investments. This platform, systems, and methods described herein utilize, in some embodiments, an individual's interest in streamed events to assist him/her with his/her financial goals, savings, and investments. In this way, individuals or groups are able to sponsor themselves as non-sponsored viewers, or third-parties are able to sponsor them as sponsored viewers, to view streaming media while earning rewards that are able to be transferred into savings or investments accounts.

Disclosed herein, in some embodiments, is a micro-savings and investment system and methods that facilitate savings and investments by people who play games, or who view streaming media. The system consists of a configuration of an Investable Game System (IGS) computer server that interacts with a database server, automated clearing house server, and game/media servers that communicate with multiple types of IGS Users. Users employ and utilize client communication devices (CCD) through a data network following methods operating on and coordinated by the IGS computer server.

One method for encouraging, engaging and motivating savings, investing, and financial asset protection is through connecting an investment system with interactive electronic game play. An electronic game is any software application or set of instructions in hardware whose usage is playful, hedonistic, educational, or entertaining. This includes but is not limited to, games that operate on in-hand gaming devices, mobile devices, gambling machines, arcade machines, gaming consoles, personal computers, and other devices that facilitate interactive electronic game play, collectively known as Client Communication Devices (CCD).

Interactive electronic game distribution and facilitation networks/platforms that host game servers, for instance, Valve Corporation's Steam® Network, Blizzard's BattleNet®, Apple iOS App Store® or Game Center®, Google Android GooglePlay® or Game Center®, and so on, provide a platform where interactive electronic games are played and a ready pool of CEU to participate.

The savings and investment methods are based on trigger antecedents and trigger action rewards associated with events detectable while playing games, or observable while viewing of streamed media. Participants who play or view are able to select and set triggers that enable the transfer of funds from a personal account like bank checking, payroll deposit accounts, debit and gift card accounts, or digital wallet to savings or investment accounts, as a result of satisfying the trigger antecedents during game playing or streaming media viewing. Participants who play or view also are able to be sponsored by a third-party that provides funds to earn for savings or investment, or be non-sponsored and transfer funds from a personal account. The content subject matter of games played or streaming media viewed is optionally entertaining, hedonistic or educational. The IGS is able to be utilized to engage in game play or streaming media viewing that is sponsored or unsponsored.

In-game triggers are optionally defined in three different categories: universal, single-variable, and multi-variable. A universal trigger is a logic or procedure that utilizes a cross application metric as its antecedent; an application metric is a metric that is common across all games. An example of a cross application metric is time. In the preferred embodiment, the universal trigger is logic that operates based on how much time has been played, has elapsed in the game, or is remaining in the game. An example of a universal trigger is “If user has played 10 minutes.” A single variable trigger is logic that utilizes a single game specific metric relating to class or instance of an in game event. Examples of game specific metrics are optionally completing a level, scoring a shot, collecting an in-game item, and so on. In the preferred embodiment, an example of a single variable trigger is “If user completes a level.” A multiple variable trigger is a logical or procedural combination of two or more single-variable triggers. An example of a multi-variable trigger is “If kill-streaks is greater than 1 and player is at stage 3 or higher.”

An event handler is that code which is assigned to process one or more triggers and assign and execute consequences to those triggers (“trigger actions”). By way of example, an event handler is able to take the trigger “If user completes a level” and add a consequence that is executed “then add $0.25 to savings account.” These in-game triggers and corresponding event handlers optionally introduce components of engagement that encourages or motivates CEU to continue their game play.

In addition to utilizing in-game triggers to drive savings and investments, assisting the CEU to set financial goals is also an effective catalyst for allocating consumer finances. For example, the CEU is able to set personal saving goals, such as, saving for a ski trip to Aspen, or an Apple laptop computer. The CEU is able to also set financial saving goals, such as, saving $100 per month, or $500 by Christmas. The CEU is also able to set game-centric, or game objective based savings goals, such as, saving $25 when he reaches level 50, or saving $10 when he scores 100 goals in game.

CCDs communicate game player data to the Game API Servers. Game API Servers provide IGS servers with CEU's game play data. IGS Servers utilize said data to trigger the events within the event handler with CEU-defined fixed or variable monetary values.

The IGS Servers are configured to intercept any game related trigger or trigger action from the Game API servers or CCD's over the data network. The IGS Servers also electronically transfer the total monetary amount to be saved during the last session of recorded play from CEU's funding source to the IGS omnibus For the Benefit Of (FBO) bank account communicated and transferred through the MTS server. The IGS servers execute a process that utilizes triggers that enable electronic monetary savings deposit transfers to IGS Databases through the bank MTS Server that includes but also not limited to, saving deposit account, withdraw settlement FBO account, and chargeback returns account.

CCD communicates with IGS server and specifies how much money to move from the CEU's available balance recorded in the IGS database server, from the FBO bank account to the financial affiliate/partner servers. This step transfers CEU's FBO to high potential growth, market-driven, investment platforms and partners, such as, Acorns, E-Trade, Robinhood, etc. The IGS System enables the CEU to define a financial objective, or goal, and the system utilizes inherent objective driven gamer behaviors to incentivize and motivate CEU through triggers or trigger actions to fulfill the financial objective or goal. The IGS System also enables the CEU to define an in-game objective, goal or mission. The IGS System then utilizes inherent objective driven game player behavior to incentivize and motivate CEU through triggers and triggers action creation to achieve the in-game objective, goal or mission for a material or immaterial reward. In addition, the IGS System communicates savings goals, financial performances, triggers, trigger actions, etc. to CCD over data network.

In an alternative embodiment, instead of the IGS Servers intercepting any game related triggers from the game servers or CCD's over the data network, the IGS Server communicate directly with the CCDs through the data network. This enables a universal event trigger to be utilized on particular CEU devices that are not necessarily connected to a game server, such as mobile smartphones or tablets.

One aspect provided herein is a micro-savings and investment platform comprising: a mobile processor on a client communication device configured to provide a mobile application comprising: a user software module configured to receive data related to a first financial account, data related to a second financial account data, a media trigger antecedent, and a media trigger action reward from the user; a media trigger detection module configured to detect an occurrence of the media trigger antecedent during an occurrence of a media; and a communication module configured to transmit a first signal based on the occurrence of the media trigger and a second signal comprising least one of the data related to the first financial account, the data related to the second financial account data, the media trigger antecedent, and the media trigger action reward; and an investable game system server processor configured to provide a server application comprising: a communication module configured to receive the first signal and the second signal; a database module configured to record the second signal; and a financial transfer module configured to initiate a transfer of a fund from the first financial account to the second financial account based on the media trigger action reward, when the communication module receives the signal based on the occurrence.

In some embodiments, the media comprises a video, a game, a learning program, or any combination thereof. In some embodiments, the media trigger antecedent comprises a viewing time period, a number of points scored, a number of wins or losses, a level achieved, a ranking, or any combination thereof. Some embodiments further comprise a Mobile Telephony Service (MTS) server configured to provide a server application comprising an Automated Clearing House (ACH). In some embodiments, at least one of the mobile application and the server application further comprise an encryption module configured to encrypt at least one of the first signal and the second signal. In some embodiments, at least one of the first financial account and the second financial account are owned by the user.

Another aspect provided herein is a computer implemented method of micro-savings and investment comprising: receiving from the user, by a client communication device, data related to a first financial account, data related to a second financial account data, a media trigger antecedent, and a media trigger action reward; detecting, by the client communication device, an occurrence of the media trigger antecedent during the display of a media; transmitting, by the client communication device, a first signal based on the occurrence of the media trigger and a second signal comprising least one of the data related to the first financial account, the data related to the second financial account data, the media trigger antecedent, and the media trigger action reward; receiving, by an investable game system, the first signal and the second signal; recording, by the investable game system, the second signal; initiating, by the investable game system, a transfer of a fund from the first financial account to the second financial account based on the media trigger action reward, when the communication module receives the signal based on the occurrence.

In some embodiments, the media comprises a video, a game, a learning program, or any combination thereof. In some embodiments, the media trigger antecedent comprises a viewing time period, a number of points scored, a number of wins or losses, a level achieved, a ranking, or any combination thereof. Some embodiments further comprise encrypting, by at least one of the client communication device and the investable game system, at least one of the first signal and the second signal. In some embodiments, at least one of the first financial account and the second financial account are owned by the user.

In another aspect provided herein is a platform configured for interception of data stream triggers, the platform comprising: (a) a) a mobile processor comprising a first computer-readable storage media, wherein the first computer-readable storage media is configured to store a sequence of mobile software application instructions which, when executed by the mobile processor, configures a client communication device to: (i) receive data related to a first account, data related to a second account, at least one trigger, and an event handler related to the at least one trigger; (ii) intercept the at least one trigger from a data stream derived from a media source; and (iii) transmit a signal based on the interception of the at least one trigger; and (b) a server processor comprising a second computer-readable storage media, wherein the second computer-readable storage media is configured to store a sequence of application instructions which, when executed by the processor, configures the server to: (i) receive the transmitted signal; and (ii) direct a sum from the first account to the second account based on the event handler related to the at least one trigger when the server receives the transmitted signal.

Optionally, in some embodiments, the at least one trigger comprises a universal trigger, a single variable trigger, a multiple variable trigger, or any combination thereof. Optionally, in some embodiments, the universal trigger comprises a viewing time period or length of time a game is played. Optionally, in some embodiments, the single variable comprises a level completed, a number of goals scored, a number of kills, or a number of head shots. Optionally, in some embodiments, the first account comprises a bank checking account, a payroll deposit account, a debit or gift card account, or a digital wallet. Optionally, in some embodiments, the second account comprises a savings account or an investment account. Optionally, in some embodiments, intercepting the at least one trigger from the data stream comprises filtering the data stream. Optionally, in other embodiments, filtering the data stream comprises listening for the at least one trigger. Optionally, in some embodiments, the media source comprises a video clip, a movie, an online video game, a shooting game, a television show, an action game, an adventure game, a platform game, a survival horror game, a role playing game, a strategy game, a sports game, a simulation game, a strategy game, an action-adventure game, a learning program, a puzzle game, or any combination thereof. Optionally, in some embodiments, the first account and the second account are commonly owned. Optionally, in some embodiments, the first account and the second account are separately owned.

In another aspect provided herein is a computer implemented method of intercepting data stream triggers, the method comprising: (a) receiving from a user, by a client communication device, data related to a first account, data related to a second account, at least one trigger, and an event handler related to the at least one trigger; (b) intercepting, by the client communication device, the at least one trigger from a data stream derived from a media source; (c) transmitting, by the client communication device, a signal based on interception of the at least one trigger; (d) receiving, by a server processor system, the transmitted signal; and (e) directing, by the server processor system, a sum from the first account to the second account based on the event handler related to the at least one trigger when the server receives the transmitted signal.

Optionally, in some embodiments, the at least one trigger comprises a universal trigger, a single variable trigger, a multiple variable trigger, or any combination thereof. Optionally, in some embodiments, the universal trigger comprises a viewing time period or length of time a game is played. Optionally, in some embodiments, the single variable comprises a level completed, a number of goals scored, a number of kills, or a number of head shots. Optionally, in some embodiments, the first account comprises a bank checking account, a payroll deposit account, a debit or gift card account, or a digital wallet. Optionally, in some embodiments, the second account comprises a savings account or an investment account. Optionally, in some embodiments, intercepting the at least one trigger from the data stream comprises filtering the data stream. Optionally, in some embodiments, filtering the data stream comprises listening for the at least one trigger. Optionally, in some embodiments, intercepting the at least one trigger from the data stream comprises listening for the at least one trigger. Optionally, in some embodiments, the media source comprises a video clip, a movie, an online video game, a shooting game, a television show, an action game, an adventure game, a platform game, a survival horror game, a role playing game, a strategy game, a sports game, a simulation game, a strategy game, an action-adventure game, a learning program, a puzzle game, or any combination thereof. Optionally, in some embodiments, the first account and the second account are owned by a same user. Optionally, in some embodiments, the first account and the second account are owned by different users. Optionally, the mobile application further configures the client communication to encrypt the transmission of the signal based on the interception of the at least one trigger.

Other platforms, systems, methods, features and advantages of the invention will be or will become apparent to one with skill in the art upon examination of the following figures and detailed description. It is intended that all such additional systems, methods, features and advantages be included within this description, be within the scope of the invention.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 shows a non-limiting example of a schematic flowchart of a system architecture in accordance with a preferred embodiment of the present invention.

FIG. 2 shows a non-limiting example of a schematic flowchart of implementation of the common game playing and streamed media viewing process for either players or viewers, in accordance with a preferred embodiment of the present invention.

FIG. 3 shows a non-limiting example of a schematic flowchart of implementation of the game player process, in accordance with a preferred embodiment of the present invention.

FIG. 4 shows a non-limiting example of a schematic flowchart of implementation of the streaming media viewer process, in accordance with a preferred embodiment of the present invention.

FIG. 5 shows a non-limiting example of a schematic flowchart of implementation of sponsor, custodian, and account manager process, in accordance with a preferred embodiment of present invention.

FIG. 6 shows a non-limiting schematic diagram of a digital processing device; in this case, a device with one or more CPUs, a memory, a communication interface, and a display.

FIG. 7 shows a non-limiting schematic diagram of a web/mobile application provision system; in this case, a system providing browser-based and/or native mobile user interfaces.

FIG. 8 shows a non-limiting schematic diagram of a cloud-based web/mobile application provision system; in this case, a system comprising an elastically load balanced, auto-scaling web server and application server resources as well synchronously replicated databases.

FIG. 9 shows a non-limiting schematic diagram of a User Interface (UI) for a CCD for game trigger selection by an Account Manager or Sponsor Curator.

FIG. 10 shows a non-limiting schematic diagram of a UI for a CCD for a Non-Sponsored Player/Sponsored Player trigger antecedents selected for different games, along with trigger action rewards earned by the Player.

FIG. 11 shows a non-limiting schematic diagram of a UI for a CCD for a Non-Sponsored Viewer/Sponsored Viewer for viewing a streaming media channel for a specific game.

FIG. 12 shows a non-limiting example of a trigger ledger of triggered events and monetary value assigned to those triggers, in accordance with a preferred embodiment of the present invention.

FIG. 13 shows a non-limiting example of an individual user accounting ledger, in accordance with a preferred embodiment of the present invention.

### DETAILED DESCRIPTION OF THE INVENTION

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

Traditionally, third-party sponsors fail to incentivize sponsees because they fail to relate to the sponsees' behavioral interests, such as video game playing and viewing streamed media broadcasts. Third-party sponsors are able to take the form of corporate entities that produce and market computer or video game related products or services, of philanthropic benefactors or foundations that want to encourage students to engage in educational game play or streamed media viewing, adult family members who want to encourage younger family members to focus and associate their game play efforts with savings and investment practices that will help earn funds for future educational opportunities or tuition, and other for-profit or non-profit enterprises that want to encourage their current or future workers to practice and acquire workplace skills that will be trained or learned through work-related game play or engagement with streaming media content.

The invention described herein relates to a micro-savings and investment system and methods that facilitate savings and investments based on trigger antecedents and trigger actions within games played or viewing of streamed media, wherein the participant is able to be sponsored by a third-party, or non-sponsored, while the content of the streamed events is optionally educational or hedonistic. The IGS System 100 is able to be utilized to engage in sponsored or unsponsored game play or streaming media viewing.

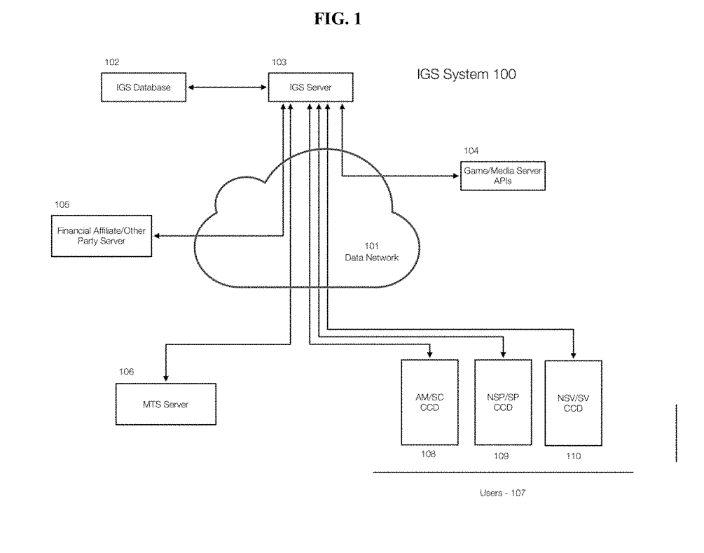

As described above, triggers and trigger actions within streamed events are optionally utilized to incentivize and motivate users for allocating consumer finances. FIG. 1 presents a non-limiting example of an IGS System 100 that facilitates long-term, intermediate-term, short-term financial savings and investments during interactive game playing or streaming media viewing is further illustrated in block-diagram form.

### Data Network

The IGS System 100 includes Data Network 101, which is a set of hardware, software, interconnected networking equipment, and data transfer protocols configured for electronic communication. Any data transfer or data processing command sequence transmitted over the Data Network 101 within the IGS System 100 is able to be secured through encryption, access control lists, User authentication, or other mechanisms that provide cybersecurity protections and information integrity assurances. For example, Data Network 101 may be any one of a global data network (e.g., the Internet), an application content or services network operating on a data network (e.g., World Wide Web), a regional data network, mobile/cellular wireless network, or a local area network. In a preferred embodiment, Data Network 101 represents a packet-switched network like the Internet for routing various data, including application content or services. The Data Network 101 uses common high-level protocols, such as TCP/IP and may comprise multiple networks of differing protocols connected through appropriate gateways. The Data Network 101 may also utilize cybersecurity protection capabilities like virtual private networks, along with blockchain-based distributed ledgering for maintaining the integrity, traceability and provenance of data transactions or command processing transactions.

### IGS Database

The IGS System 100 includes IGS Database 102. The IGS Database 102 may utilize any type of storage device or storage medium such as remote cloud storage, local hard disks, compact disks, and may also include a collection of devices, for storing and organizing data arising from IGS System 100 usage and operation. Similarly, it should be understood that IGS Server 103 and IGS Database 102 optionally reside on the same computing device, or on different computing devices connected through a data network. The information from IGS Database 102 is accessed, queried, and updated through its connection to the IGS Server 103, which in turn communicates with other IGS System 100 components over the Data Network 101, through respective network connections, represented as solid lines in FIG. 1. These network connections are wired or wireless, and are implemented using known data communication protocols. IGS Database 102 stores electronic files representing financial savings and deposit fund account information for Users 107, including both individual and collective savings deposit funds.

In the preferred embodiment, IGS Database 102 represents a collective financial savings scheme, such as storing user savings and deposits in a Federal Deposit Insurance Corporation (FDIC) savings bank account. In the same embodiment, IGS Database 102 also stores information regarding the Users and triggers, such as different User profiles (e.g., Account Manager (AM), Sponsor/Custodian (SC), Sponsored Player (SP), Non-sponsored Player (NSP), Sponsored Viewer (SV), Non-sponsored Viewer (NSV), etc.), streamed media trigger antecedent data (e.g., minutes viewed, goals scored, baskets made), game play trigger action metrics (e.g., wins/losses, kills, deaths, bombs planted, bombs defused, time played), in-game variables (e.g., tokens, coins, gold, scores, levels, arena maps, experience points), and so on. Streamed media and in-game trigger antecedents include, but are not limited to, specified observable streamed media data values or time markers, game telemetry metrics and in-game play variables. Similarly, trigger actions may denote monetary amounts for savings or investment, or other rewards earned, associated with trigger antecedent satisfaction.

In some embodiments, the IGS Database 102 utilizes available database management system functionality to support secondary data analytic functions or data mining applications, report generation, and data visualization displays for delivery to IGS System 100 operator, Financial Affiliate/Other Party Server 105 or AM/SC CCD 108. In additional embodiments, data analytics functions applied to the IGS Database 102 produce reports and visual displays on games played or streams viewed, duration of games played, game session scores, number of triggers selected, triggers antecedents satisfied, etc. Similarly, in some embodiments, data mining applications produce reports or displays of statistical derivations of game player performance scores across different games played correlated with time of day played, tournaments entered, tournament winnings, etc., as well as regression coefficients on projected game player performance scores for all players on a professional eSports game playing team compared across competing teams. In further embodiments, the IGS Database 102 supports functionality for blockchains, distributed ledgers and smart contracts for automatically managing, securing, and provenance tracking of User transactions communicated to/from the IGS Server 103.

### IGS Server

The IGS System 100 includes IGS Server 103. This Server accesses and communicates data, data updates, and data transaction commands to the IGS Database 102 through a private backend data communications link or virtual private network. The IGS Server 103 also communicates data transmitted, transferred, or otherwise updated over the Data Network 101, from both the User 107 as well as Game/Media Server APIs 104. IGS Server 103 is a program that provides data interchange and coordinates services to other programs and users in the same or other computers, including those connected via the Data Network 101. The computer on which the IGS Server 103 program operates is referred to as a server. The IGS Server 103 may be a dedicated server, cloud hosted server, shared hosted server, and so on.

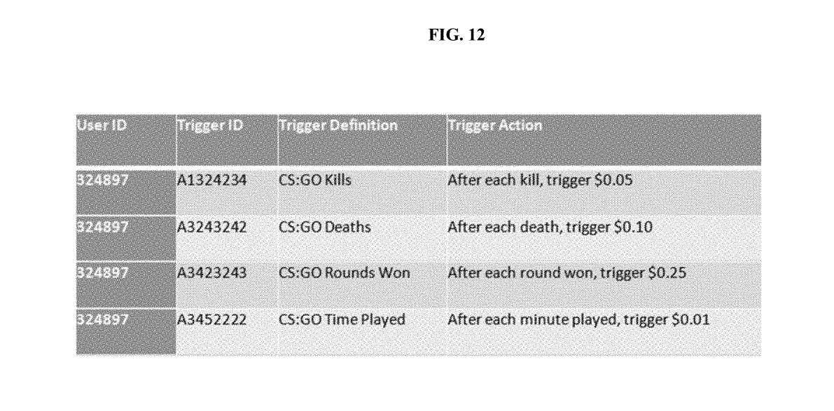

In the preferred embodiment, IGS Servers access Game API Server over said Data Network, or IGS Servers access CCD directly over said Data Network, to keep an accurate trigger ledger of triggered events and monetary value assigned to those triggers as in FIG. 12 through the IGS Servers. CEUs assign or select monetary values of triggers on the CCD associated with each game, which is stored in the IGS Database. The functions included with keeping the trigger ledger include but are not limited to: creating triggers, intercepting triggers, storing trigger actions, updating investment account, calculating the overall monetary amount to be saved per session of recorded play, electronically communicating the total to the CCD, funds earned, saved, invested, deposited, withdrawn and returned.

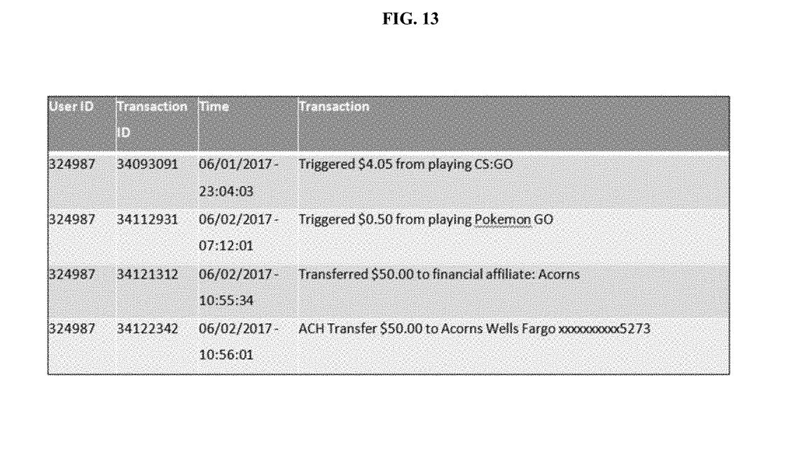

Additionally, the CEU will assign monetary values to triggers as part of creating a trigger action. This in turn will be used by the event handler to process financial savings per event handler activation for the assigned monetary value from the CEU connected bank account to FDIC savings account communicated through ACH Server 106 through Data Network 101 to the IGS Server 103 and stored in individual user accounting ledgers as in FIG. 13 on IGS Database 102. In alternate embodiments the accounting ledger may reside in a distributed or remote database such as blockchain. The user/client assigns monetary values to nearly every aspect of interactive game play utilizing in-game event triggers. For example, a Counter-Strike Global Offensives player using IGS System 100 customizes his trigger and trigger actions so that when they play financial savings of $0.10 per kill scored, $0.50 per bomb planted, $1.00 per bomb defused are processed by the IGS System.

### Game or Media Server APIs

The IGS System 100 further includes a Game or Media Server APIs 104 communicatively linked through the Data Network 101 to the IGS Server 102. An application programming interface (API) is a particular set of specifications, formats, and rules that software programs follow to connect and communicate with each other. It serves as an interface between different computer programs and facilitates their interaction, similar to the way the user interface facilitates interaction between humans and computers. The Game or Media APIs Server 104, is a particular set of specifications, formats, and rules, in an open form of software code where game data is communicated either publicly or privately through the Data Network 101 to the IGS Server 103. Examples of Game or Media Server APIs 104 are a Steam API from Valve Corporation, League of Legends API from Riot Games, Sony Playstation Network API, and so on supporting game playing and play event transmission that is accessible by the Data Network 101. Alternatively, Game or Media Server APIs 104 are the NFL API from the National Football League, the Twitch API from Twitch Inc., the stats.nba.com API from the National Basketball Association, the ESPN API from the ESPN broadcast network development center, or others supporting streaming media viewing.

### Financial Affiliate Server/Other Party Server

The IGS System 100 includes Financial Affiliate Server or Other Party Server 105. Financial Affiliate Server or Other Party Server 105 is an investment platform accessible by the IGS System 100. Examples of investment platforms associated with IGS System 100 include, but are not limited to, Acorns™, Robin Hood™, Stash™, E-Trade™, and so on. SP, NSP, SV, and NSV Users have the option to transfer savings initiated using triggers from their FDIC insured savings account to said investment platforms. This occurs, for example, when a User initiates the transfer from CCD 107 through Data Network 101 to IGS Server 103. When a User initiates such transfers, their personal savings account data transaction updates are communicated from/to the IGS Database 102 and IGS Server 103 through Data Network 101 to Money Transfer System (MTS) Server 106 to Financial Affiliate Server 105 through Data Network 101.

### MTS Server

The IGS System 100 also includes MTS Server 106. An Automated Clearing House (ACH) is a secure payment transfer system that connects to established financial institutions like U.S. banks. The MTS Server 106 acts as the central clearing facility for all Electronic Fund Transfer (EFT) transactions that occur nationwide, representing a crucial link in the national banking system. It is here that payments and debits may wait for clearance for transfer to their final banking destination. Most financial institutions in the U.S. transmit or receive ACH entries through ACH operators such as the American Clearing House Association, the Federal Reserve, the Electronic Payments Network, PayPal, Venmo, and Visa. The MTS Server is optionally the current bank ACH system, a shared ledger, PayPal, Venmo, and other money transfer systems. The MTS Server 106 supports a set of transactions from the IGS Server. These transactions are either deposits or withdrawals. These transactions include, but are not limited to, NSP/SV funding source to/from IGS FBO Bank Account, SC funding source to/from IGS FBO Bank Account, IGS FBO Bank Account to/from Affiliate Partner Server 105. Transactions “to” are deposits, and transactions “from” are withdrawals. The IGS FBO Account manages the balance of funds for each IGS System 100 User.

### User Devices

The IGS System 100 interfaces with User Devices 107 represented by CCD 108, 109, 110. These CCDs are optionally portable communication devices, such as mobile phones, laptop computers, personal digital assistants (PDA), or portable multimedia players. However, CCD 108, 109, 110 also include laptops, desktops, multiprocessor systems, microprocessor-based systems, programmable consumer electronics, telephony systems, distributed computing environments, set top boxes, console gaming systems, and so on. CCD 108, 109, 110 may further include a User Interface (UI) devices such as a touch screen display monitor (not shown) or hand-held game controller (not shown), to allow a User to provide input to the game (e.g., game commands through direction buttons, keyboards, dials, joysticks, and so on), or input to control the streaming media presentation. For example, a User is able to move an in-game character, change their in-game point-of-view, select and move an in-game object, or aim and shoot an in-game weapon at an opponent, based on manipulation of direction controls/buttons. The UI devices are optionally utilized by Users 107 to select trigger antecedents and set trigger action values that affect savings and transfer of funds associated with game playing or streaming media viewing results, through Users navigation of trigger selection menus and movement of trigger action value sliders. The UI devices may also be configured to pre-set various system parameters as trigger antecedents for a given game or streaming media broadcast, whose activation or satisfaction cause corresponding trigger actions to be affected. CCD 108, 109, 110 may also be used to collect information such as investment metrics, payment information, investment variables, game controls, streaming media controls, trigger (antecedent) selections and corresponding trigger action value settings, as well as external application accessibility. CCD 108, 109, 110 are configured to allow Users to connect to the Data Network 101, such as to IGS Server 103.

In the preferred embodiment for AM/SC, a Sponsor connects the funding source using CCD 108 through the Data Network 101 to IGS System 100 and through Data Network 101 connects to Financial Affiliate Server 105. The Sponsor is able to assign themselves or another person, group, or automated mechanism to serve as AM to manage and oversee the allocation of funds through CCD 108 through the Data Network 101 to IGS System 100. AM selects the trigger antecedents and then sets the trigger action values the sponsees, SP/SV, will use to initiate saving transfers on CCD 108. Selected SP/SV's triggers and antecedent satisfaction action values are uploaded through Data Network 101 to the IGS Server 103, and transmitted and stored on the IGS Database 102. After SP/SV plays an interactive video game, or views a streamed media session on CCD 109/110, where the game or media data is stored, the game play data and trigger actions result data are transmitted from CCD 108 through Data Network 101 to Game/Media Server APIs 104, where the relevant API is updated via the data transmission. The IGS Server 103 accesses Game/Media Server APIs 104 and intercepts SP/SV game or media data. IGS Server 103 communicates SP game play or SV streaming media viewing data to IGS Database 102. IGS Database 102 processes SP/SV game data communicated and processed by the IGS Server 103 with the corresponding trigger antecedents that AM has selected and set with the computational event handlers that affect the trigger actions, which initiate a financial savings transfer request through MTS Server from Sponsor's funding source to IGS FBO bank account. SP/SV, as the recipient of the funds, then have the option presented through the UI on the CCD to either leave funds saved in IGS FBO bank account, or transfer to potentially higher yielding long-term or short-term investment platforms from IGS FBO bank account through MTS Server 106 to other financial institutions.

For example, the Bank of America Charitable Foundation or Sponsor, is able to delegate using a computer, CCD 108, a member staff of the University of California (UC)'s eSports Program to serve in the role as AM for their eSports scholarship program. The member staff of the UC Program will select and set the triggers for sponsored students (as SP/SV) on IGS System 100 through an AM/SC CCD. After the sponsored students (SP/SV) have finished playing the games, IGS System 100 collects and processes the trigger data and produces online reports for the AM on their AM/SC CCD. The AM approves student trigger results and the students receive scholarship funding on behalf of the Bank of America Charitable Foundation.

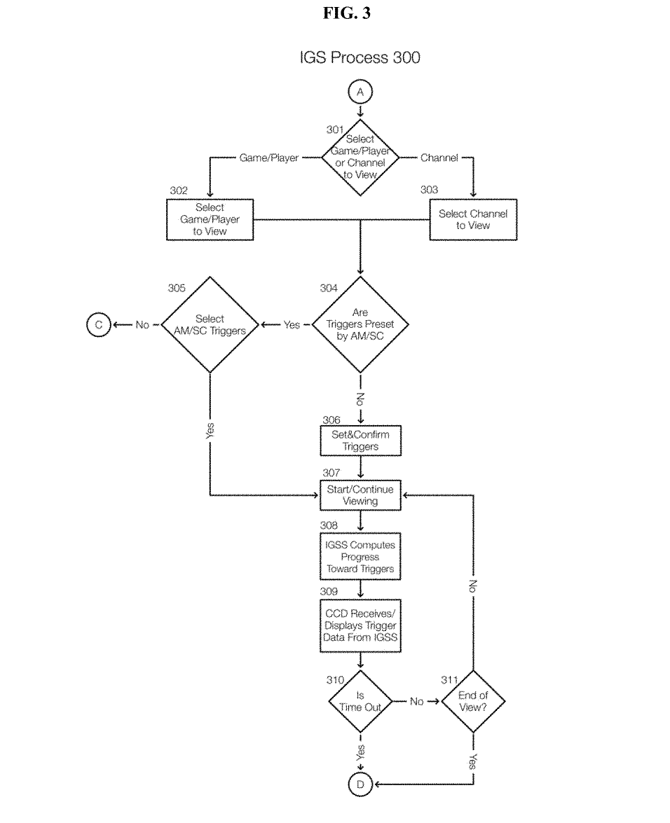

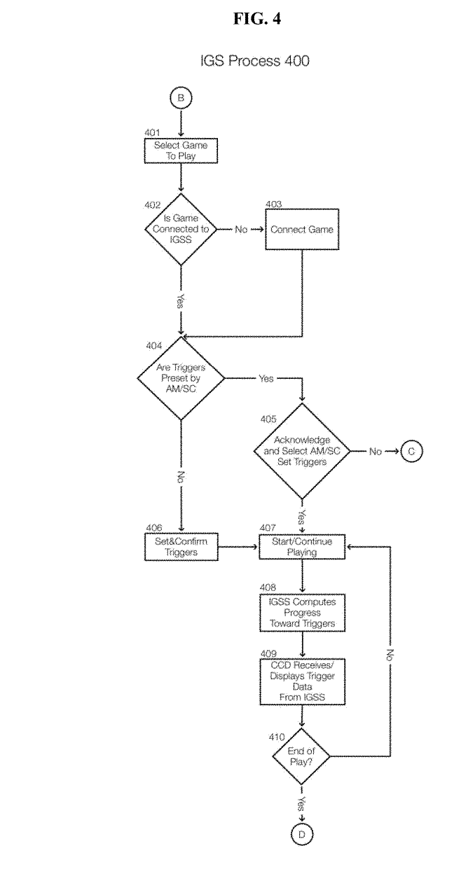

In the alternative embodiment for AM/SC, SC connects the funding source using CCD 108 through the Data Network 101 to IGS System 100, and through Data Network 101 connects to Financial Affiliate Server 105. SC manages and oversees the allocation of funds through CCD 108 through the Data Network 101 to IGS System 100. SC selects the trigger antecedents and then sets the trigger action values the sponsees, SP/SV, will use to initiate saving transfers on CCD 108. Selected SP/SV's triggers and antecedent satisfaction action values are uploaded through Data Network 101 to the IGS Server 103, and transmitted and stored on the IGS Database 102, as shown in FIG. 3 and FIG. 4. After SP/SV plays an interactive video game, or views a streamed media session, on CCD 109 for the SP or CCD 110 for SV, where the game or media data is stored, the game play data is transmitted from CCD 108 through Data Network 101 to Game or Media APIs Server 104, where the API is updated. The IGS Server 103 accesses Game or Media APIs Server 104 and intercepts SP/SV game or media data. IGS Server 103 communicates SP/SV game or media data to IGS Database 102. IGS Database 102 processes SP/SV game data with the corresponding triggers that AM has selected and set with the trigger action event handlers that initiate financial savings transfer request through MTS Server from SC's funding source to IGS FBO bank account. SP/SV, as the recipient of the funds, then have the option to either leave funds saved in IGS FBO bank account or transfer to potentially higher yielding long-term or short-term investment platforms from IGS FBO bank account through MTS Server 106 to other financial institutions.

For example, Jane (AM/SC) is a parent who wants her son John (NSP to become a SP) to become a player of educational games. To incentivize John, Jane opens a sponsor account, and transfers to IGS FBO bank account $500 for John to earn his way towards a new Microsoft XBox One X video game console system. She selects a trigger with a time-based antecedent (for amount of time played) for educational games available via the Games/Media Server APIs, and then sets the trigger action of $1 earned/saved per hour (from her sponsor account to John's FBO account) of educational game played. If Jane approves John's trigger action results at the end of the week, the funds are transferred into John's FBO account. If Jane does not approve, then there no funds are transferred from her sponsor account to John's FBO account. When John has played 500 hours of educational games that Jane has approved, John will have the option to transfer the $500 in his FBO account to either a personal account from which he will later purchase a new XBox One X console system, or he is able to transfer the amount to another investment channel available through the Financial Affiliate/Other Party Server 105 to invest for his future.

In the preferred embodiment, SP acknowledges and selects one or more of the triggers set by AM/SC using CCD 109. The SP selected triggers, when satisfied, will affect trigger actions that initiate deposit transactions on CCD 109. The trigger action data is uploaded through Data Network 101 to the IGS Server 103 and transmitted and stored on the IGS Database 102. SP plays an interactive video game on CCD 109, where the game data is stored. The SP game play data that originates from CCD 109 is transmitted from CCD 109 through Data Network 101 to Game or Media Server APIs 104, through a means that is independent of IGS System 100, where the data is updated and stored. IGS Server 103 accesses Game or Media Server APIs 104 and intercepts SP game data. IGS Server 103 communicates SP game data to IGS Database 102. IGS Database 102 collects and processes SP game data with SP trigger action event handlers and reports SP game data summary to AM/SC for review. After AM/SC approval, IGS Server 103 initiates financial savings deposit transaction request through MTS Server 106 from SC funding source to IGS FBO bank account. SP then have the option to either leave funds saved in IGS FBO bank account or transfer to potentially higher yielding long-term or short-term investment platforms from IGS FBO bank account through MTS Server 106 to other financial institutions.

For example, an SP from eSports team Cloud9 acknowledges and selects eSports game tournament sponsor Intel (AM/SC) recommended trigger antecedents for in-game players killed on the game, Counter-Strike: Global Offensive, where the trigger satisfaction action is set to save/earn 50 cents per kill. The SP's triggers are stored on the IGS Database. SP achieves 130 kills in a session on his gaming PC, or CCD 109. The CCD, the player's gaming PC, independently communicates with the Game Server, for example, Valve's Steam Network API, that the SP has killed 130 enemies in his current play session. That information is communicated from the Game Server API 104 to the IGS Server 103, and then communicated to IGS Database 102. Next, the trigger antecedent conditions, when satisfied, execute the trigger consequence reward assignments and add them to the corresponding user IGS FBO account. For example, each in-game kill accomplished assigns 50 cents to be transferred from IGS FBO Account for Intel into IGS FBO Account for SP. The IGS Server 103 calculates 130 kills multiplied by 50 cents for the result of $65.00, then initiates a $65 transfer through the MTS Server 106 from the IGS FBO Account for Intel to the FBO bank account for the SP. SP later is able to transfer this saving of $65.00 to an ETrade account, through MTS Server 106 though Data Network 101 to Financial Affiliate Server 105, where SP has option to purchase stocks or bonds.

In the alternate embodiment, NSP selects and sets which triggers will initiate saving deposit transactions on his CCD 109 from his personal account. These trigger selections and action settings are then uploaded through Data Network 101 to the IGS Server 103 and transmitted and stored on the IGS Database 102. NSP plays an interactive video game on CCD 109, where the game data is stored or streamed. The NSP game play data that originates from CCD 109 is transmitted from CCD 108 through Data Network 101 to Game or Media Server APIs 104, through a means that is independent of IGS System 100, where the data is updated and stored. The IGS Server 103 accesses Game or Media API Server 104 and intercepts NSP game data. IGS Server 103 communicates NSP game data to IGS Database 102. IGS Database 102 processes NSP game data with NSP triggers with event handlers and initiates financial savings transfer request through MTS Server from NSP funding source to IGS FBO bank account. NSP then has the option to either leave funds saved in IGS FBO bank account, or transfer to potentially higher yielding long-term or short-term investment platforms from IGS FBO bank account through MTS Server 106 to other financial institutions.

For example, NSP sets trigger actions for kill triggers on the game, Counter-Strike: Global Offensive, for 50 cents per kill. The NSP's triggers are stored on the IGS Database. NSP achieves 100 kills in a session on his gaming PC, or CCD 109. The CCD, the player's gaming PC, independently communicates with the Game Server, for example, Valve's Steam Network API, that the NSP has killed 100 enemies in his current play session. That information is communicated from the Game Server API 104 to the IGS Server 103, and then communicated to IGS Database 102. This occurs as the trigger antecedent conditions when satisfied execute the trigger consequence reward assignments and adds it to the corresponding user IGS FBO account. For example, the IGS Server 103 calculates 100 kills multiplied by 50 cents is $50.00 and initiates a $50 transfer through the MTS Server 106 from the NSP's bank account to the FBO bank account. NSP later is able to transfer this saving of $50.00 to an ETrade account, through MTS Server 106 though Data Network 101 to Financial Affiliate Server 105, where NSP has option to purchase stocks or bonds.

In the preferred embodiment, SV confirms triggers set by AM/SC using CCD 110. The triggers will initiate saving transfers on SV CCD 110 and the trigger data is uploaded through Data Network 101 to the IGS Server 103 and transmitted and stored on the IGS Database 102. SP plays an interactive video game on CCD 108, where the game or media data is stored or streamed. The SV gameplay data that originates from CCD 110 is transmitted from CCD 110 through Data Network 101 to Game or Media Server APIs 104, through a means that is independent of IGS System 100, where the data is updated and stored. IGS Server 103 accesses Game or Media API Server 104 and intercepts SP game data. IGS Server 103 communicates SP game data to IGS Database 102. IGS Database 102 collects and processes SV game data with SV triggers with event handlers and submits to AM/SC for review. After AM/SC completes their review, IGS Server 103 initiates financial savings transfer request through MTS Server from SC bank account to IGS FBO bank account. SP then has the option to either leave funds saved in IGS FBO bank account or transfer to potentially higher yielding long-term or short-term investment platforms from IGS FBO bank account through MTS Server 106 to designate other financial institutions.

For example, a student receiving performance-based scholarships at a university taking a science course acknowledges and selects his/her time-based trigger set for completing and viewing a course-related online streaming science video lecture series. Upon completion of viewing the lecture series, his/her performance accomplishment will be reported to the scholarship administrator, acting in the role of AM/SC.

In the alternate embodiment, NSV sets up and configures which triggers will initiate saving transfers on his CCD 110 and the triggers are uploaded through Data Network 101 to the IGS Server 103 and transmitted and stored on the IGS Database 102. NSV plays an interactive video game on CCD 110, where the game or media data is stored or streamed. The NSV game play data that originates from CCD 110 is transmitted from CCD 110 through Data Network 101 to Game/Media Server APIs 104, through a means that is independent of IGS System 100, where the data is updated and stored. The IGS Server 103 accesses Game/Media Server APIs 104 and intercepts NSV game data. IGS Server 103 communicates NSV game data to IGS Database 102. IGS Database 102 processes NSP/NSV game data with NSV/NSV triggers with event handlers and initiates a financial savings transfer request through MTS Server from NSV bank account to IGS FBO bank account. NSV then has the option to either leave funds saved in IGS FBO bank account or transfer to potentially higher yielding long-term or short-term investment platforms from IGS FBO bank account through MTS Server 106 to designate other financial institutions.

For example, NSV sets trigger actions for an NBA game between the Cleveland Cavaliers and the Golden State Warriors based on individual player's performance. The player NSV has set trigger actions on LeBron James of the Cleveland Cavaliers, and the trigger actions are on his field goals made, at a trigger amount of $1.00 saved per field goal made. The NSV's triggers are stored on the IGS Database 102. The player, LeBron James, has scored 15 field goals in the specific game. National Basketball Association updates the NBA API, as the relevant Game/Media Server API 104, that LeBron James has made 15 field goals in the specific game. That information is updated to IGS Server 103, and is communicated to IGS Database 102, where each field goal is translated into $1.00 transferred. The IGS Database 102 calculates 15 field goals multiplied by $1.00 is $15.00 and then initiates a $15.00 transfer via MTS Server 106 from NSV's bank account to the FBO bank account. NSV later is able to transfer this savings of $15.00 to an investment account through Financial Affiliate Server 105, where NSV will have other investment options. This savings is optionally transferred automatically by the IGS System 100 through financial investment advising algorithms.

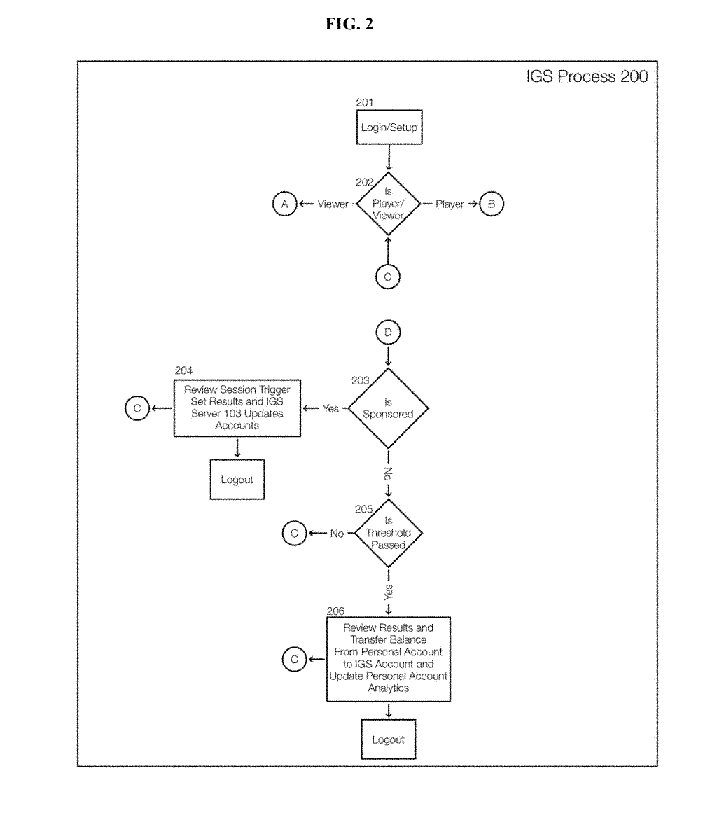

In the preferred embodiment, the SV/NSV begins IGS Process 200 in FIG. 2 by logging in to the IGS System 100 or signing up to IGS System 100 in a similar process known within the financial technology industry (action block 201), with SV/NSV registering with his/her personal credentials and connecting his/her personal checking and bank savings accounts to the IGS MTS Server 106. Once the User is logged into the IGS System 100 on CCD 109 or 110, an option (action block 202) is provided for User to select if they are a viewer or a player. If the User is a Viewer, they perform IGS Process 300, shown in FIG. 3. After the Viewer completes the IGS Process 300, either by timing out or ending their viewing session, the Viewer returns to complete or continue IGS Process 200 from action block 203. Alternatively, if the User is a Player, they perform IGS Process 400, shown in FIG. 4. After the Player completes the IGS Process 400 by ending their play, the Player returns to complete or continue IGS Process 200 from action block 203.

If the IGS System 100 already has determined the Viewer or Player is sponsored at action block 203, the IGS System 100 enables the SV/SP to review their session trigger action reward results they have earned on their respective CCD at action block 203. In addition, the IGS Server 103 has collected the session trigger data from the CCD to update the SV/SP account information tracked by the IGS Database 102 and related savings or investment account information associated with the User, also at action block 203. Then the SV/SP is able to restart with a new Viewer/Player session at action block 202, or log out.

Alternatively, if the IGS System 100 already has determined the Viewer or Player is not sponsored at action block 203, the IGS System 100 analyzes if the NSV/NSP has met the money transfer threshold at action block 205. If the money transfer threshold to batch bank transfers is reached, for example, a threshold value of $5.00 or $10.00, a money transfer request is initiated by IGS System 100 at action block 206. This action connects analyzing and updating the NSV data from the viewing session. If the money transfer threshold is not reached, the status progress is stored in the IGS System 100, and the NSV is able to restart with a new viewing session at action block 202, or log out.

When the User is a viewer, at action block 202, they next select at action block 301 the option of which content to view: either a game/player or streaming media channel to view. If the option selected is to view a game, then SV/NSV proceeds to 302 to select a game to view, for example, the game Counter-Strike: Global Offensive to view. Furthermore, the viewer at action block 302 is able to select a specific player to view, for example, Jake “Stewie2K” Yip from Team Cloud9 at action block 302. Alternatively, SV/NSV is able to select a streaming media channel to view at action block 303, such as, NBA TV or “ESL_CSGOb” on Twitch.

Next, the User is determined to be a SV if their triggers are preset by the AM/SC at action block 304. Once the user is determined to be a SV, they have the option to select all, some, or none of the triggers made available by the AM/SC at action block 305. These trigger antecedents and trigger action values are presented on the UI operating on the CCD 110. If the SV does not select any of the triggers at action block 305, they will restart the IGS System 100 player setup process at action block 202, and optionally the SV communicates the issue with the AM/SC in some appropriate manner, such as via a separate email message. Availability and presentation on the UI of CCD 110 of triggers preset by the AM/SC determines whether or not the User is a SV or NSV.

Next, if the SV selects and sets the triggers at action block 305, they proceed to start or continue viewing the game, player, or streaming media channel at action block 307. As the viewing session for game, player, or streaming media channel selected by the SV is now active, IGS System 100 computes progress towards satisfying the trigger antecedents indicated by the viewer, by way of data collected from Game and Media Server APIs 104 at action block 308. The progress results are then communicated and updated as trigger actions displayed on the CCD 110 UI, at action block 309. If the viewer is a SV, action block 309 also affects the transfer of AM/SC assigned funding values or rewards to the SV.

In addition to these actions, during the IGS Process 300, the IGS System 100 periodically performs status updates to SV CCD 110. This checks if SV viewing session has either timed out at action block 310, or has ended at action block 311. If the SV has ended their viewing session at action block 311, or the session has timed out at action block 310, the SV returns to IGS Process 200 ready to proceed to action block 203.

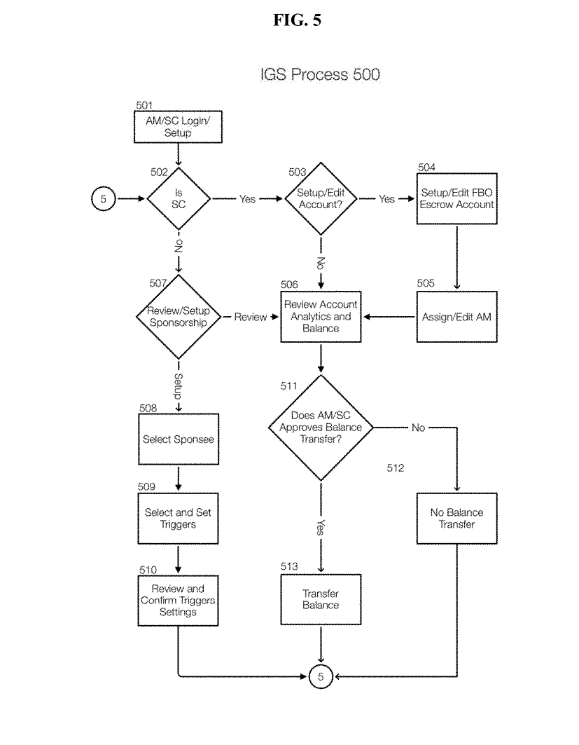

If the IGS System 100 has determined that the viewer is a SV at action block 203, AM/SC receives viewing session trigger data set results from IGS System 100 in action block 204. The IGS Server 103 then updates the SV and AM/SC accounts for trigger antecedents satisfied, and trigger action rewards balance earned by the SV. This action by the AM/SC also appears in FIG. 5 at action block 506. Such a transfer of data, for example, may communicate the progress made in the number of triggers satisfied per minute and the average time to satisfy selected triggers, for the streamed media viewing session. SV then has the option to logout of IGS System 100, or restart another viewing/playing session at action block 202.

If the Viewer in IGS Process 300 is an NSV, this is determined if there are no triggers are preset by the AM/SC at action block 304. Once the user is determined as a NSV, they select from available trigger antecedents at action block 306 provided by the IGS Server 103. These trigger antecedents and trigger action values are presented on the UI operating on the CCD 110. Availability and presentation on the UI of CCD 110 of triggers preset by the AM/SC determines whether or not the User is a SV or NSV.

Next, after the NSV selects and sets the triggers at action block 306, they proceed to start or continue viewing the game, player, or streaming media channel at action block 307. As the viewing session for game, player, or streaming media channel selected by the NSV is active, IGS System 100 computes progress towards satisfying the trigger antecedents indicated by the viewer, by way of data collected from Game and Media Server APIs 104 at action block 308. The progress results are then communicated and updated as trigger actions displayed on the CCD 110 UI, at action block 309. The updated trigger data is pushed through Data Network 101 to the SV CCD 110 at action block 309.

In addition to these actions during the IGS Process 300, the IGS System 100 periodically performs status updates to SV CCD 110. This checks if NSV viewing session has either timed out at action block 310, or has ended at action block 311. If the NSV has ended their viewing session at action block 311, or the session has timed out at action block 310, the NSV returns to IGS Process 200 ready to proceed to action block 203.

In the preferred embodiment, the SP/NSP begins IGS Process 200 in FIG. 2 by logging into the IGS System 100 or signing up to IGS System 100 in similar process known within the financial technology industry (action block 201), with SP/NSP registering with his/her personal credentials, connecting his bank account to the IGS MTS Server 106. Once SP/NSP is officially on-boarded to the IGS System 100 on SP/NSP CCD 109, the SP/NSP is able to select if they are a Viewer or a Player. Since SP/NSP is a Player, SP/NSP proceeds to select a game to play (action block 401).

After SP/NSP selects a game to play, IGS System 100 determines if the game selected is already setup and connected to the IGS System 100 (action block 402). For example, this may check to see if the SP/NSP has selected a game like Valve's Counter Strike: Global Operations, or Blizzard's World of Warcraft. If the game selected is not set up and connected to the IGS System 100, or if security token for the selected game has expired, then the SP/NSP must connect the game to the IGS System 100 at action block 403 by registering as a user/player for such game through means that may utilize the Game and Media APIs Server 104, or utilize an interface external to the IGS System 100. After the selected game is connected to the IGS System 100, the player determines whether the triggers are preset by AM/SC (action block 404). If the triggers are preset by the AM/SC, then the player is a SP, and proceeds to action block 405 to select and set the trigger from those present by the AM/SC, then proceeds to action block 407. If the SP selects none of the triggers preset by the AM/SC at action block 405, the SP returns to action block 202 to restart the IGS Process 200, and optionally the SP communicates the issue with the AM/SC. On the other hand, if the triggers are not preset by AM/SC, then the player is a NSP, and then the NSP proceeds to select, set and confirm triggers at action block 406.

As the SP/NSP game session is ready to start or continue play subject to trigger antecedents selected and trigger action consequences set at action block 407, the IGS System 100 collects and computes the trigger data from Game and Media APIs Server 104 and processes the trigger antecedent satisfaction and trigger action results that assign rewards or funding values earned (action block 408). The updated trigger data is sent through Data Network 101 to the SP CCD 109 (action block 409).

Next, If the SP/NSP has ended his/her play session (action block 410), the Player returns to IGS Process 200 to continue at action block 203. If the IGS System 100 has confirmed that the Player is a SP (action block 203), then the SP is able to review the trigger action set results for rewards earned at action block 204. The IGS System 100 also transmits a report on SP account analytics and rewards earned balance resulting from the recorded game play, which is then communicated to the AM/SC for approval via IGS Process 500 at action block 506, FIG. 5. Examples of account analytics includes identification of games played, game play duration, game session scores, number of triggers selected, triggers antecedents satisfied, etc. After SP submits trigger results to AM/SC, SP is able to restart with a new game session at action block 202 or log out.

Alternatively, if the Player is an NSP at action block 203, the IGS System 100 analyzes if NSP has met the money transfer threshold at action block 205. If the money transfer threshold to batch bank transfers is reached, for example, a threshold value of $5.00 or $10.00, a money transfer request is initiated by IGS System 100 at action block 206. This action connects analyzing and updating the NSP data from the game session, and then transferring the balance of trigger action reward funds earned from the NSP personal account to the IGS FBO account, along with updating the personal account analytics. If the money transfer threshold is not reached, the status progress is stored in the IGS System 100, and the NSP is able to restart with a new game session at action block 202 or log out.

In the preferred embodiment, the AM/SC begins IGS Process 500 shown in FIG. 5 by logging in to the IGS System 100 or signing up to IGS System 100 in similar process known within the financial technology industry (action block 501). The next action begins an ongoing process iteration that begins when the User is determined to act either (action block 502) as Sponsor/Custodian (SC) before proceeding (to action block 503), or if not then as an AM before proceeding (to action block 507). This iteration continues until the AM/SC has dispersed all the funds they have assigned and designated for transfer to their selected sponsees, or until the AM/SC FBO account balance goes to zero for whatever reason. Process iteration may also be suspended at one time and resumed at a later time, for the convenience of the AM/SC, or until the AM/SC account balance goes to zero. If or when the AM/SC account balance is zero, the AM/SC is able to restart the IGS Process 500 by setting up a new account, or by replenishing the balance of funds in their AM/SC account through other means outside of the IGS System 100.

Next, when the SC is determined at action block 502, then they will have a choice (action block 503) to either (a) setup or edit their SC bank account information for use with the IGS MTS Server 106 as an FBO account and then deposit sponsoring funds into said account (action block 504), or else (b) to proceed to review data analytics and rewards/funds earned balance for the Viewers or Players accounts sponsored by the SC (action block 506). Either activity may be repeated or iterated many times during IGS Process 500, depending on the interests and assignment/replenishment of funds provided by the SC. In addition, if the SC has chosen (b), they next assign or edit their choice for who will serve on their behalf as the SC's Account Manager (action block 506), before the AM/SC reviews the data analytics and rewards/funds earned balance for the Player or Viewers accounts sponsored by the SC (action block 506). In this way, the AM acts to oversee the sponsees (SV) viewing session, or the sponsees (SP) playing session, trigger action results and reward funds earned. This assignment/editing of the AM choice by the SC allows for the SC to serve as AM by default, or to assign a third-party to manage the FBO account as AM (action block 506). Similarly, after SV views a streaming media session, or SP plays a game session, the IGS System 100 captures and stored transmits trigger action results as session data in the IGS Database 102 via the IGS Server 103, and this data is made available to the AM for review (action block 506) via the CCD 108.

Alternatively, when the User is not an SC at action block 502, they are recognized as a previously assigned AM, as a result of an earlier iteration of the IGS Process 500. In this case, the AM is then able to either set up: sponsorship relations with one or more sponsees they select as SV/SP; or else review the account analytics and balance of funds or rewards earned for their SV/SP sponsees (action block 506) they have selected in a prior iteration of the IGS Process 500.

The AM is presented option to select and set triggers (action block 509) for the sponsees selected by the AM (action block 508). If no triggers have been selected and set for the sponsees, then AM will select and set triggers individually or as a group (action block 509). After trigger antecedents for sponsees are selected and the trigger action values set (action block 509), or there are existing triggers for sponsees, the AM then reviews and confirm the trigger antecedent and trigger action settings (action block 510) for the sponsees the AM selected at action block 508. The AM decides (action block 507) to either proceed to review SP/SV performance account analytics and balance, by again navigating IGS Process 500 to once again be able to perform this review (action block 506) before continuing to either approve or not the balance transfer for the SV/SP for the trigger action rewards or funds earned.

The AM approves (action block 513), denies, or defers (action block 512) the transfer of the escrowed funds balance (action block 511) already earned by the SV/SP in one or more ways. For example, in a first way, the AM selects and sets (i.e., preset) triggers for their corresponding SV/SP that are presented on the UI of the CCD 109/110, which when the trigger antecedents are satisfied, the trigger actions are affected and funds earned by the SP/SV are then transferred into their FBO account via the MTS Server 106 for savings or via the Financial Partner server 105 for investment. In some embodiments, the AM reviews and then approves, denies, or defers the transfer of funds in the SP/SV escrow account, and, if approved, then the escrowed funds are released for transfer into the SP/SV personal account for savings or investment. In a third way, the AM on behalf of the SC, or the SC directly as AM, is able to provide an assessment form, compliance questionnaire, or similar evaluation instrument to determine whether the SV/SP is able to demonstrate that they have satisfactorily learned, been trained, or completed compliance requirements for subject matter conveyed through game play or streaming media viewing, based on achievement of a suitable performance score threshold. If the score threshold is reached, the escrowed funds are transferred into the SP/SV personal account for savings or investment, otherwise, the SV/SP is encouraged to continue their playing or viewing before retaking the assessment activity. After the AM/SC determines whether or not to approve the transfer of earned reward funds balance on behalf of the SV/SP, the AM/SC optionally returns to repeat the IGS Process 500 for other sponsees they are sponsoring, until the SC funds in their FBO accounts have all been transferred or withdrawn.

### Digital Processing Device

In some embodiments, the platforms, systems, media, and methods described herein include a digital processing device, or use of the same. In further embodiments, the digital processing device includes one or more hardware central processing units (CPUs) or general purpose graphics processing units (GPGPUs) that carry out the device's computation and user interface display functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, tablet/pad computers, set-top computers, media streaming devices, handheld computers, Internet appliances, mobile smartphones, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In yet other embodiments, the display is a head-mounted display in communication with the digital processing device, such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, trackpad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

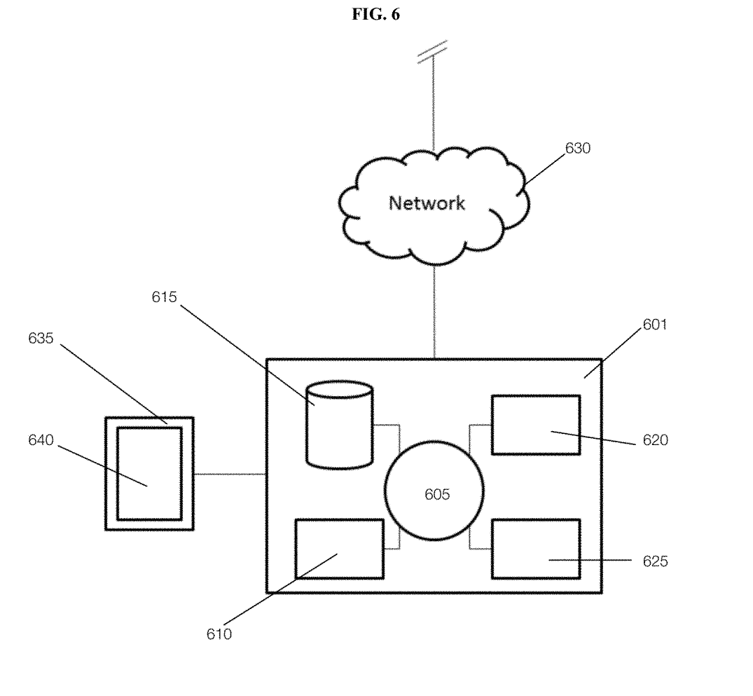

Referring to FIG. 6, in a particular embodiment, an exemplary digital processing device 601 includes a central processing unit (CPU, also “processor” and “computer processor” herein), which is optionally a single core or multi core processor, or a plurality of processors for parallel processing. The digital processing device 601 also includes memory or memory location 610 (e.g., random-access memory, read-only memory, flash memory), electronic storage unit 615 (e.g., hard disk), communication interface 620 (e.g., network adapter) for communicating with one or more other systems, and peripheral devices 625, such as cache, other memory, data storage and/or electronic display adapters. The memory 610, storage unit 615, interface 620 and peripheral devices 625 are in communication with the CPU 605 through a communication bus (solid lines), such as a motherboard. The storage unit 615 is optionally be a data storage unit (or data repository) for storing data. The digital processing device 601 is optionally operatively coupled to a computer network (“network”) 630 with the aid of the communication interface 620. The network 630 is optionally the Internet, an internet and/or extranet, or an intranet and/or extranet that is in communication with the Internet. The network 630 in some cases is a telecommunication and/or data network. The network 630 optionally includes one or more computer servers, which enable distributed computing, such as cloud computing. The network 630, in some cases with the aid of the device 601, optionally implements a peer-to-peer network, which may enable devices coupled to the device 601 to behave as a client or a server.

Continuing to refer to FIG. 6, the CPU 605 optionally executes a sequence of machine-readable instructions, which is embodied in a program or software. The instructions may be stored in a memory location, such as the memory 610. The instructions are optionally directed to the CPU 605, which subsequently programs or otherwise configures the CPU 605 to implement methods of the present disclosure. Examples of operations performed by the CPU 605 include fetch, decode, execute, and write back. The CPU 605 is optionally part of a circuit, such as an integrated circuit. One or more other components of the device 601 are optionally included in the circuit. In some cases, the circuit is an application specific integrated circuit (ASIC) or a field programmable gate array (FPGA).

Continuing to refer to FIG. 6, the storage unit 615 optionally stores files, such as drivers, libraries and saved programs. In some embodiments, the storage unit 615 stores user data, e.g., user preferences and user programs. The digital processing device 601, in some cases, includes one or more additional data storage units that are external, such as located on a remote server that is in communication through an intranet or the Internet.

Continuing to refer to FIG. 6, the digital processing device 601 optionally communicates with one or more remote computer systems through the network 630. For instance, in an exemplary embodiment, the device 601 communicates with a remote computer system of a user. Examples of remote computer systems include personal computers (e.g., portable PC), slate or tablet PCs (e.g., Apple® iPad, Samsung® Galaxy Tab), telephones, Smart phones (e.g., Apple® iPhone, Android-enabled device, Blackberry®), or personal digital assistants.

Methods as described herein are optionally implemented by way of machine (e.g., computer processor) executable code stored on an electronic storage location of the digital processing device 601, such as, for example, on the memory 610 or electronic storage unit 615. The machine executable or machine readable code is optionally provided in the form of software. During use, the code is executed by the processor. In some cases, the code is retrieved from the storage unit 615 and stored on the memory 610 for ready access by the processor 605. In some situations, the electronic storage unit 615 is precluded, and machine-executable instructions are stored on memory 610. Last, the digital processing device 601 communicates to computer communications device 635 that device users utilize to communicate and interact with the digital processing device 601, based on data or other information presented to users on the visual display 640 associated with device 635.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer/PC Program

In some embodiments, the platforms, systems, media, and methods disclosed herein include at least one computer program, or use of the same. A computer program, including those that operate on a Personal Computer (PC), entails a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone PC applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™ Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

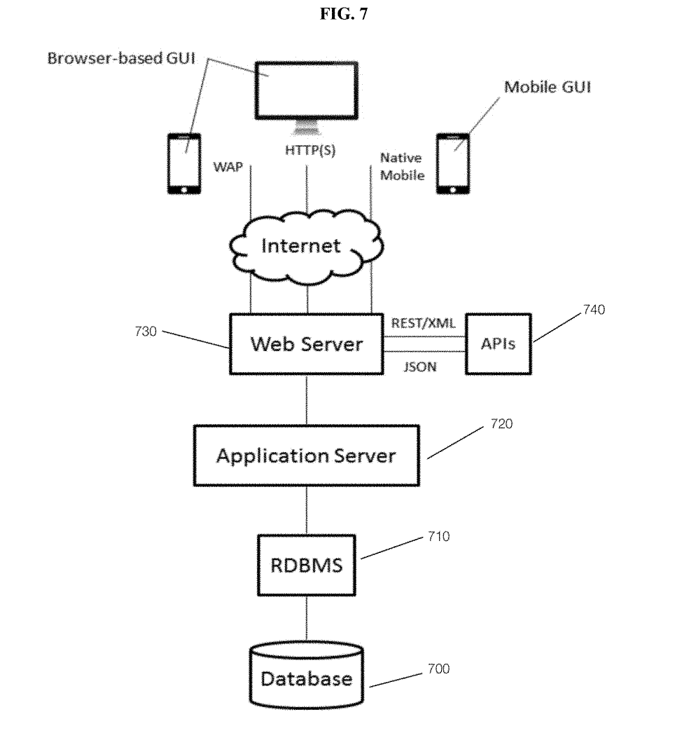

Referring to FIG. 7, in a particular embodiment, a Web/mobile application provision system comprises one or more databases 700 accessed by a relational database management system (RDBMS) 710. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application servers 720 (such as Java servers, .NET servers, PHP servers, and the like) and one or more web servers 730 (such as Apache, IIS, GWS and the like). The web server(s) optionally expose one or more web services via app application programming interfaces (APIs) 740. Via a network, such as the Internet, the system provides browser-based and/or mobile native user interfaces.

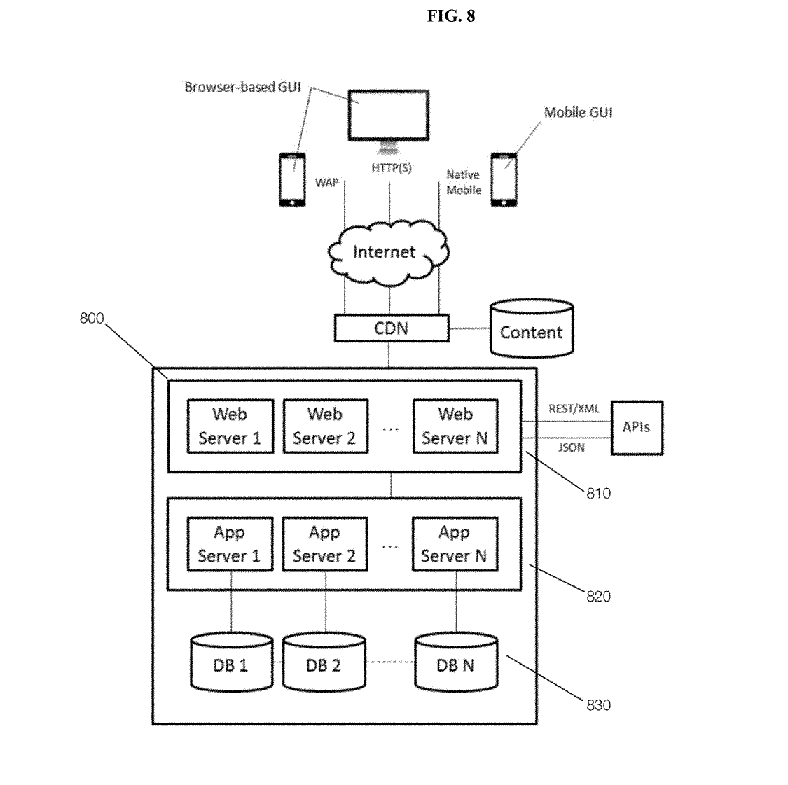

Referring to FIG. 8, in a particular embodiment, a PC/mobile application provision system alternatively has a distributed, cloud-based architecture 800 and comprises elastically load balanced, auto-scaling web server resources 810 and application server resources 820 as well synchronously replicated databases 830.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirPlay SDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Computer/PC Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable compiled applications.

### Web Browser Plug-in

In some embodiments, the computer program includes a web browser plug-in (e.g., extension, etc.). In computing, a plug-in is one or more software components that adds specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called micro-browsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of learner, tutor, curriculum, progress, and performance information. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is Internet-based. In further embodiments, a database is web-based. In still further embodiments, a database is cloud computing-based. In other embodiments, a database is based on one or more local computer storage devices.

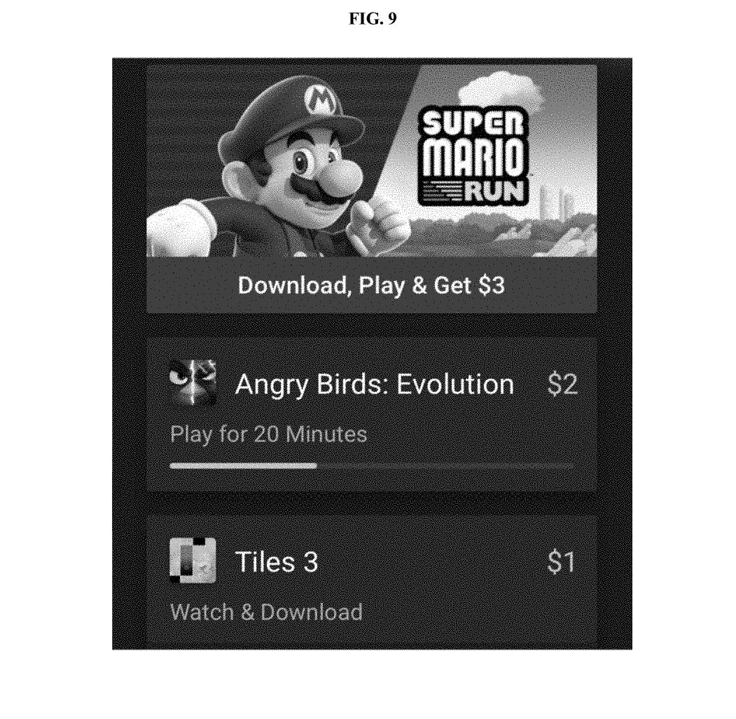

Following this, FIG. 9 shows a non-limiting schematic diagram of a User Interface (UI) for a CCD 108, for an Account Manager or Sponsor Curator for selecting a game and a play time duration trigger.

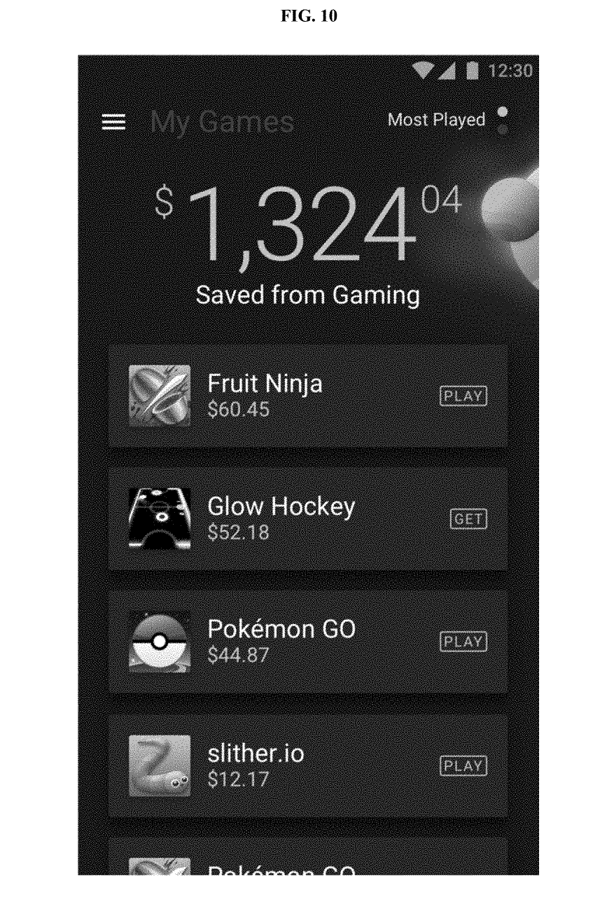

Next, FIG. 10 shows a non-limiting schematic diagram of a UI for a CCD 109, for a Non-Sponsored Player/Sponsored Player who has selected trigger antecedents (not seen) and trigger action value earnings (shown) for different games, in addition to total reward funds earned so far.

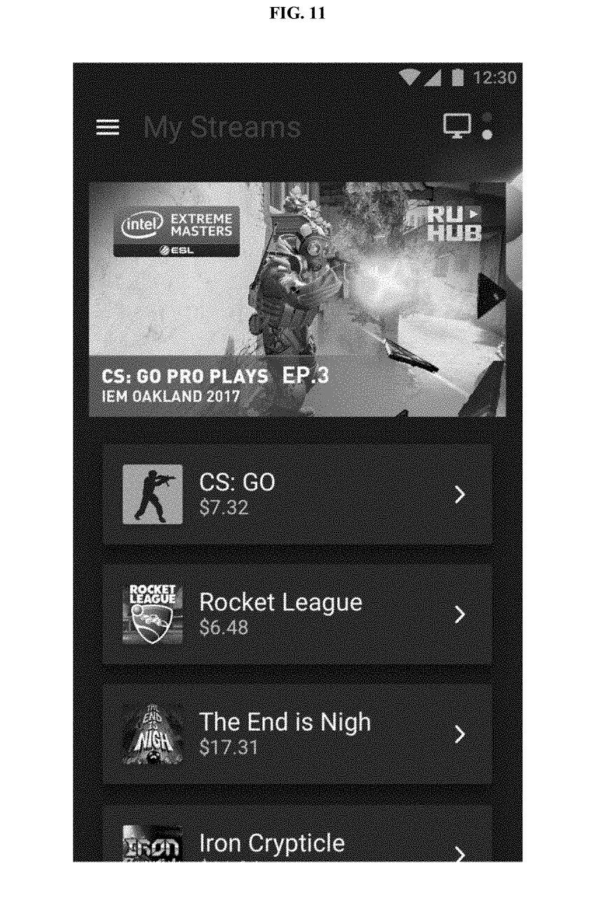

Last, FIG. 11 shows a non-limiting schematic diagram of a UI for a CCD 110, for a Non-Sponsored Viewer/Sponsored Viewer for viewing streaming media, for example, an Internet video of a specific game.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by about 10%, 5%, or 1%, including increments therein.

Sponsored or non-sponsored game playing and streaming media viewing: playing of computer, electronic or video games, or viewing of streaming media, to earn rewards for saving or investment provided by third-party sponsors, or provided by the non-sponsored participants themselves when there is no third-party sponsor.

Playing: to experience, enact, perform, modify, or make games or streaming media. Players refer to an individual or group of persons, computer programs, or other automated mechanisms that engage in playing.

Viewing: to observe, watch, listen, feel, or add annotations to a game broadcast or other streaming media. Viewers refer to an individual or group of persons, computer programs, or other automated mechanisms that engage in viewing.

Games: any software application or sports game broadcast suitable for entertainment, hedonistic enjoyment, educational training/learning experiences, or other game/media interests of players or viewers.

Streaming media: any digital media used for recording, transmitting, rendering, playing or replaying games, including games hosted on remote servers or broadcast on television, radio, or the Internet. Media may entail video, audio, textual, social messaging, printed materials, digitally sensed physical objects, or interactively navigable hypermedia content related to games or associated subjects.

Trigger: A mechanism that detects and evaluates computational events that arise during game playing or streaming media viewing. The trigger mechanism entails a conditional antecedent expression pertaining to a specific type of event or logical expression pertaining to a type of event (“A”), such that if/when A is true or otherwise satisfied, then a procedural computation or declarative assignment consequence action (“B”) is performed. If A is not true or not satisfied, then no action is performed, and the trigger has no effect. The antecedent expression A and consequent action B may include variables whose value is set by a game player, streaming media viewer, or third-party. Triggers are selected for different types of events of interest or reward challenge such as, but not limited to, elapsed time played/viewed, health points decrement/increment, resource captured/lost, weapon shots, hits/misses, text chat posts, notifications sent/received, etc. Variables associated with such events may include, but not limited to, time duration, shots attempted counts, ammo balance count, target hit counts, dollars earned, specified resource used/consumed, questions answered correctly, etc. Player, viewers, or third-parties may assign, declare, specify or otherwise set unit values for variables they select as numerical constants, maximum/minimum constraints, or some amount determined by calculation or referral to an external server interface. A game selected by a game player for play, or a streaming media selected by a viewer to view, may accommodate one or more triggers for selection, along with setting the values for the trigger variables. Triggers provide a basis for earning rewards associated with game playing and streaming media viewing achievements, results or outcome. A group of triggers are optionally packaged together as a common goal or as reusable missions to be fulfilled by a player or a viewer. Examples may include but are not limited to a group of triggers for: download, install, and play one or more games until a threshold is reached to earn rewards; watch a set of videos, complete a quiz and earn a set of rewards; make or modify game assets for others to download and earn rewards; complete corporate training games/videos to earn rewards.

Rewards: monetary units, objects, or signifiers whose observable value is denominated in ratio, interval, ordinal, or nominal units such as US dollars, Bitcoin cryptocurrency, game tier/level advancements, leaderboard positions, badges, loyalty program points, mystery/loot boxes, etc. Rewards may be earned through, or result from, playing, or viewing. Earning or receipt of rewards may entail engagement of game play or streaming media based mechanisms that sense, monitor, measure, guide, control, replay, assess, or evaluate performance accomplishments of players or viewers before, during, or after their play or view experience. Earning or receipt of in-game rewards and in-stream rewards are optionally associated with trigger antecedents managed and tracked by the IGS System 100 on behalf of Users who have selected such triggers, and set trigger action consequences/results as the basis for Users receiving external rewards, that are also managed and tracked by the IGS System 100 on behalf of Users. Earning or receipt of rewards follow from satisfying trigger antecedents that may be presented singularly, in multiples or sets, or as a composite goal-oriented mission for completion. In-game or in-stream rewards may be received as in-game resources or streaming media objects that are recognized as point scores, new weapons, health points, game skins, Easter Eggs, keys to open locks, unlocked levels, etc. Earning or receipt of external rewards provided by Sponsor/Custodian, or assigned for earning by an Account Manager, to individual Users or group of Users. These earnings or receipt of external rewards are set as trigger actions associated with their trigger antecedents. Non-funds rewards may be converted into monetary units or inter-game digital assets for trading, saving, or investment when permitted.

Next, the IGS System 100 is built around Client Communication Devices (CCDs) utilized by IGS System 100 Users (collectively addressed as Users). In addition to the IGS System 100 Operator who controls and manages systems operations, Users 107 include people or automated mechanisms that act in one or more of the following roles, sequentially or concurrently, over time as follows:

Non-Sponsored Player (NSP): A first type of User is a Non-Sponsored Player (NSP). A NSP is a game playing user who playing utilizes event action triggers within an interactive video game, sports game, educational game, work related game, or some other game playing activity as a method to save and invest. An example of a NSP is someone who is saving using universal (time based) and in-game action triggers to save and invest while playing the League of Legends game online.

Sponsored Player (SP): A second type of User is a Sponsored Player (SP). A SP is a game playing user whose playing is incentivized, through material or immaterial means, by a third-party sponsor to complete specific game playing objectives or goals. An example of SP is a professional video game eSports player who is sponsored by Coca Cola, and the player receives performance-based incentives and other rewards as a result of their game play performance accomplishments.

Non-Sponsored Viewer (NSV): A third type of User is a Non-Sponsored Viewer (NSV). A NSV is a spectating user whose viewing entails selecting trigger antecedents and setting trigger result actions for streamed media of game play on a broadcast channel, as the basis for saving and investing. An example of a NSV is an National Football League (NFL) fan who is viewing a live cable TV, Internet, social media, or branded network broadcast of the Oakland Raiders versus Atlanta Falcons football game while saving and investing based on action or event happening within the game, such as total ground yardage and touchdowns scored by Oakland, and passing yardage and field goals scored by Atlanta. In another example, one or more NSVs may act as a game viewer cohort who collectively take on the role of AM/SC to sponsor their favorite professional eSports game players/teams, or to contribute funds to a crowdfunded common pool that is divided among a game's winning players by ranked outcome (first place, second place, etc.).

Sponsored Viewer (SV): A fourth type of User is a Sponsored Viewer (SV). A SV is a spectating user whose streaming media viewing is incentivized, through material or immaterial means, by a third-party sponsor to complete specific objectives, or goals. An example of SV is an employee who is completing his/her job training video for the company's annual compliance review, or a high school student watching a science lecture video, then providing answers to questions within an online learning assessment quiz (i.e., add annotations), as part of the high school's course curriculum.

Account Manager (AM): A fifth type of User is an Account Manager (AM). The AM is a user who manages the funds provided by a sponsor for the benefit of SP/SV. The AM identifies or selects the trigger antecedents and sets trigger action reward values to offer SP/SV. An example of an AM is a school teacher who is managing an eSports scholarship program sponsored by the Bank of America Charitable Foundation. The teacher is responsible with managing the students in-game triggers and provide the charity with validation for the students to receive scholarship grants.

Sponsor or Custodian (SC): A sixth type of User are account sponsor or custodians (SC). A sponsor is optionally a game studio, corporation, advertiser, charity, philanthropic benefactor, family member, training department, workforce development center, game viewer cohort, educational foundation, or similar which provides rewards as funds either directly to sponsees, or direct to an AM to manage the disbursement. A sponsor is optionally an individual (unitary) or group (multitude), and a group is optionally persistent or ephemeral (brought together as a one-time crowd). A custodian manages the assignments of funds for the player or viewer on behalf of the sponsor, and is optionally a parent, designated representative, executor, patron, personal account business manager, or guardian of a user under the age of opening a savings and/or investment account. In some embodiments, the sponsor is the custodian, or the sponsor assigns another party to serve as custodian. An SC alternatively provides guidelines or policies that are encoded into trigger antecedents for how funds are earned, and trigger actions for how funds are disbursed or distributed to the sponsored players or viewers. These guidelines or policies may be assigned and enforced by the AM. In another example, one or more NSP may act to become a short-duration or single session playing engagement SC that select and set triggers that incentivize expert-level players or streaming media influencers to provide mentoring to viewers in how the expert players performed one or more designated in-game accomplishments, situated in-game play events, or maneuvers that enabled the expert player to realize competitive advantage over game play opponents, or to improve reward earnings. In yet another example, SC may select and set triggers that incentivize viewers to add chat comments that favorably mention or endorse a branded corporate Sponsor product or service, or to complete online training assessment questionnaires, in response to a streaming media broadcast event they view.

What is claimed is:

1) A platform configured for interception of data stream triggers, the platform comprising:
a) a mobile processor comprising a first computer-readable storage media, wherein the first computer-readable storage media is configured to store a sequence of mobile software application instructions which, when executed by the mobile processor, configures a client communication device to:
i) receive data related to a first account, data related to a second account, at least one trigger, and an event handler related to the at least one trigger;
ii) intercept the at least one trigger from a data stream derived from a media source; and
iii) transmit a signal based on the interception of the at least one trigger; and
b) a server processor comprising a second computer-readable storage media, wherein the second computer-readable storage media is configured to store a sequence of application instructions which, when executed by the processor, configures the server to:
i) receive the transmitted signal; and
ii) direct a sum from the first account to the second account based on the event handler related to the at least one trigger when the server receives the transmitted signal.

2) The platform of claim 1, wherein the at least one trigger comprises a universal trigger, a single variable trigger, a multiple variable trigger, or any combination thereof.

3) The platform of claim 2, wherein the universal trigger comprises a viewing time period or length of time a game is played.

4) The platform of claim 2, wherein the single variable comprises a level completed, a number of goals scored, a number of kills, or a number of head shots.

5) The platform of claim 1, wherein the first account comprises a bank checking account, a payroll deposit account, a debit or gift card account, or a digital wallet.

6) The platform of claim 1, wherein the second account comprises a savings account or an investment account.

7) The platform of claim 1, wherein intercepting the at least one trigger from the data stream comprises filtering the data stream.

8) The platform of claim 7, wherein filtering the data stream comprises listening for the at least one trigger.

9) The platform of claim 1, wherein intercepting the at least one trigger from the data stream comprises listening for the at least one trigger.

10) The platform of claim 1, wherein the media source comprises a video clip, a movie, an online video game, a shooting game, a television show, an action game, an adventure game, a platform game, a survival horror game, a role playing game, a strategy game, a sports game, a simulation game, a strategy game, an action-adventure game, a learning program, a puzzle game, or any combination thereof.

11) The platform of claim 1, wherein the first account and the second account are commonly owned.

12) The platform of claim 1, wherein the first account and the second account are separately owned.

13) The platform of claim 1, wherein the mobile application further configures the client communication to encrypt the transmission of the signal based on the interception of the at least one trigger.

14) A computer implemented method of intercepting data stream triggers, the method comprising:
a) receiving from a user, by a client communication device, data related to a first account, data related to a second account, at least one trigger, and an event handler related to the at least one trigger;
b) intercepting, by the client communication device, the at least one trigger from a data stream derived from a media source;
c) transmitting, by the client communication device, a signal based on interception of the at least one trigger;
d) receiving, by a server processor system, the transmitted signal; and
e) directing, by the server processor system, a sum from the first account to the second account based on the event handler related to the at least one trigger when the server receives the transmitted signal.

15) The method of claim 14, wherein the at least one trigger comprises a universal trigger, a single variable trigger, a multiple variable trigger, or any combination thereof.

16) The method of claim 14, wherein the universal trigger comprises a viewing time period or length of time a game is played.

17) The method of claim 14, wherein the single variable comprises a level completed, a number of goals scored, a number of kills, or a number of head shots.

18) The method of claim 14, wherein the first account comprises a bank checking account, a payroll deposit account, a debit or gift card account, or a digital wallet.

19) The method of claim 14, wherein the second account comprises a savings account or an investment account.

20) The method of claim 14, wherein intercepting the at least one trigger from the data stream comprises filtering the data stream.

21) The method of claim 20, wherein filtering the data stream comprises listening for the at least one trigger.

22) The method of claim 14, wherein intercepting the at least one trigger from the data stream comprises listening for the at least one trigger.

23) The method of claim 14, wherein the media source comprises a video clip, a movie, an online video game, a shooting game, a television show, an action game, an adventure game, a platform game, a survival horror game, a role playing game, a strategy game, a sports game, a simulation game, a strategy game, an action-adventure game, a learning program, a puzzle game, or any combination thereof.

24) The method of claim 14, wherein the first account and the second account are owned by a same user.

25) The method of claim 14, wherein the first account and the second account are owned by different users.

26) The method of claim 14, wherein the mobile application further configures the client communication to encrypt the transmission of the signal based on the interception of the at least one trigger.
